(19) United States
(12) Patent Application Publication
(10) Pub. No.: US 2008/0155598 A1
(43) Pub. Date: Jun. 26, 2008

(54) IMAGE DISPLAY APPARATUS AND METHOD FOR DISPLAYING BROADCAST SCHEDULE LIST

(75) Inventors: Joo-heon LEE, Suwon-si (KR); Hee-ju Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/771,220

(22) Filed: Jun. 29, 2007

(30) Foreign Application Priority Data
Dec. 21, 2006 (KR) 10-2006-0131646

(51) Int. Cl. H04N 5/445

(52) U.S. Cl. 725/39

(57) ABSTRACT

An image display apparatus and method for displaying a broadcast schedule list are provided. The image display apparatus includes a storage unit which stores information on broadcast programs scheduled for broadcasting, and a controller which reads out the stored broadcast program information so that the information is displayed in the form of a sliding banner on one side of a screen. Therefore, a user may easily confirm the broadcast schedule list without accessing the corresponding menu individually in order to check the scheduled broadcast programs. Additionally, an obstacle to viewing broadcasts caused by having to check the schedule list may be reduced, and thus user convenience can be enhanced.

### CROSS-REFERENCE TO RELATED APPLICATIONS

This application claims priority under 35 U.S.C. § 119 from Korean Patent Application No. 10-2006-0131646, filed on Dec. 21, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to displaying a broadcast, and more particularly, to displaying a broadcast on which information regarding programs scheduled for broadcasting may be displayed.

2. Description of the Related Art

Each broadcasting station providing terrestrial broadcasting, cable broadcasting, and satellite broadcasting, provides an Electronic Program Guide (EPG) which enables a viewer to receive broadcast program information directly from image display apparatuses, such as televisions (TVs), without accessing other media such as newspapers and magazines.

The EPG information, together with a video stream and an audio stream of the digital broadcasting, are compressed into a transport stream (TS), and transmitted to a TV. The TV receives, tunes and demodulates the TS, and the demodulated stream is demultiplexed to extract the video stream, audio stream, and EPG information. The TV may provide a user with the broadcast program information through the EPG information.

The EPG information allows a user to receive the broadcast program information to schedule in advance a broadcast program which the user desires to view or record. If a viewer schedules a broadcast program, a current channel may be switched to a channel of the scheduled broadcast program at the broadcasting time of the broadcast program scheduled through the EPG information.

A list of broadcast programs scheduled by a user is displayed by various methods. Since the number of lists of the scheduled broadcast programs capable of being displayed on a single screen of a display apparatus is limited, as the number of lists of scheduled broadcast programs increases, several operations need to be repeated in order to check broadcast programs not displayed on a single screen or to delete the scheduled broadcast programs, which causes inconvenience.

Additionally, a broadcast schedule list is generally displayed on the center of the screen, and thus the list covers a broadcast currently being displayed to provide a user inconvenience. In addition, if a broadcast program scheduled to be recorded is being received, it is impossible for a user to recognize information on the broadcast program being recorded and the recording progress.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for displaying an image in which a broadcast schedule list is displayed in the form of a sliding banner so that a user can conveniently check the list.

According to an aspect of the present invention, there is provided an image display apparatus comprising a storage unit which stores information on broadcast programs scheduled for broadcasting; and a controller which reads out the stored broadcast program information so that the information is displayed in the form of a sliding banner on one side of a screen.

The apparatus may further comprise a user interface unit which receives user input regarding a sliding banner display period and the number of broadcast programs to be displayed in the form of the sliding banner. The controller may read out from the storage unit the broadcast program information for as many as the number of the broadcast programs input through the user interface unit, and arrange the read broadcast program information in the order of the broadcasting time to display the information in the form of the sliding banner according to the input sliding banner display period.

The controller may cause a light to flash on the screen to indicate information on a currently received broadcast program from the broadcast program information displayed in the form of the sliding banner, if the broadcast programs scheduled for broadcasting are received.

The controller may cause a light to flash on the screen to indicate information on a currently received broadcast program from the broadcast program information displayed in the form of the sliding banner, and to alternately display a recording progress bar indicating the recording status of the currently received broadcast program and the sliding banner, if a broadcast program scheduled for recording is received.

The controller may display a recording progress bar indicating the recording status, if the broadcast programs scheduled for broadcasting are received and recorded.

The controller may alternately display the recording progress bar and the sliding banner.

The controller may display the broadcast program information in the form of the sliding banner at the bottom of the screen.

The controller may change at least one of the display color, the font size and the display text of the information on the currently received broadcast program from the broadcast program information displayed in the form of the sliding banner to a type different from information on other broadcast programs, and display the information, if one of the broadcast programs scheduled for broadcasting is received.

The broadcast schedule may be one of a viewing schedule and a recording schedule.

According to another aspect of the present invention, there is provided a method for displaying a broadcast schedule list of an image display apparatus, the method comprising reading out information on broadcast programs pre-scheduled for broadcasting, if a broadcast schedule enable command is input; and displaying the read broadcast program information in the form of a sliding banner on one side of a screen.

The displaying may comprise arranging the broadcast program information for as many as a preset number of broadcast programs in the order of the broadcasting time so that the information is displayed in the form of the sliding banner according to a regular period.

The method may further comprising having a light flashing to indicate information on a currently received broadcast program from the broadcast program information displayed in the form of the sliding banner, if the broadcast programs scheduled for broadcasting are received.

The sliding banner on which the light flashes may be displayed alternately with a recording progress bar indicating the recording status, if a broadcast program scheduled for recording is received.

The method may further comprise displaying a recording progress bar indicating the recording status, if the broadcast programs scheduled for broadcasting are received and recorded.

The recording progress bar may be displayed alternately with the sliding banner.

The displaying may comprise displaying the broadcast program information in the form of the sliding banner at the bottom of the screen.

The method may further comprise changing at least one of the display color, the font size and the display text of the information on the currently received broadcast program from the broadcast program information displayed in the form of the sliding banner to a type different from information on other broadcast programs, and displaying the information, if one of the broadcast programs scheduled for broadcasting is received.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of an image display apparatus according to an exemplary embodiment of the present invention;

FIG. 2 is a detailed block diagram of the image display apparatus of FIG. 1;

FIGS. 3 to 5B are exemplary views showing a broadcast schedule list displayed on a screen, according to an exemplary embodiment of the present invention;

FIG. 6 is a flowchart explaining a method for displaying a broadcast schedule list of an image display apparatus according to another exemplary embodiment of the present invention; and

FIG. 7 is a flowchart explaining in detail the method of FIG. 6 according to another exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure exemplary embodiments of the present invention with unnecessary detail.

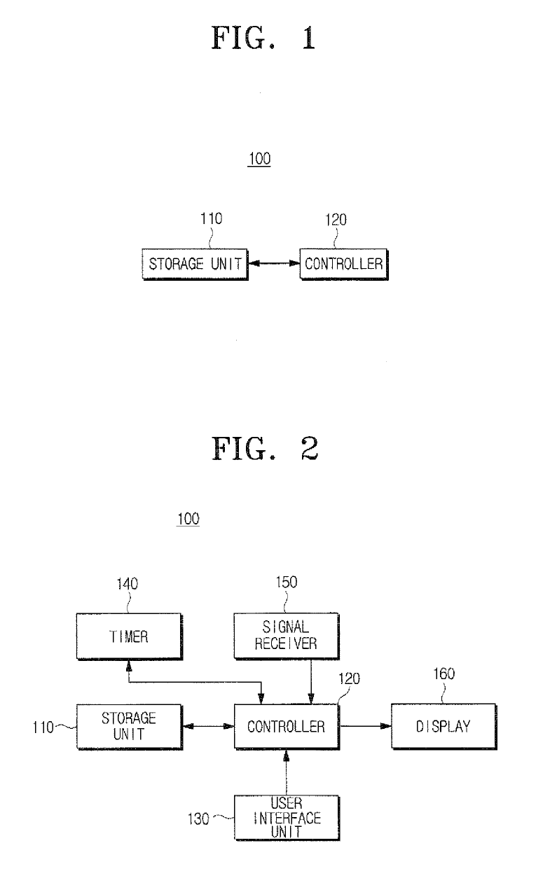

FIG. 1 is a block diagram of an image display apparatus according to an exemplary embodiment of the present invention. In FIG. 1, an image display apparatus 100 comprises a storage unit 110 and a controller 120. The image display apparatus 100 may enable a user to schedule broadcast programs using broadcast program information provided from an Electronic Program Guide (EPG).

The storage unit 110 stores information on broadcast programs scheduled for broadcasting. This broadcast program information is sorted and stored according to the broadcast program. The broadcast program information may comprise information relating to the name of the broadcasting station providing the broadcast program, the channel number of the received broadcast, the broadcasting time of the broadcast program, and the broadcast program title.

The controller 120 reads out the information on the scheduled broadcast programs so that the information can be displayed in the form of a sliding banner on one side of a screen. The controller 120 checks the broadcasting time of the scheduled broadcast program, and reads out information on scheduled broadcast programs which have not been displayed in their entirety at the current time to display the information in the form of the sliding banner. The broadcast schedules may comprise viewing schedules or recording schedules.

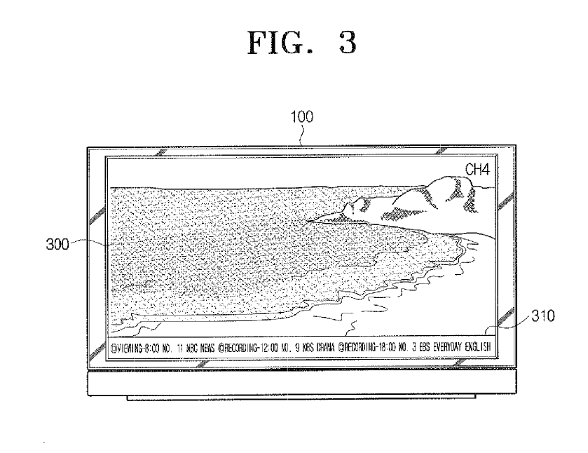

FIG. 2 is a detailed block diagram of the image display apparatus of FIG. 1. In FIG. 2, the image display apparatus 100 comprises a user interface unit 130, a timer 140, a signal receiver 150, and a display 160, in addition to the storage unit 110 and controller 120 of FIG. 1.

The user interface unit 130 receives input regarding the sliding banner display period and the number of scheduled broadcast programs displayed in the form of the sliding banner. The user interface unit 130 displays the EPG information received through the signal receiver 150, and a user interface capable of selecting a broadcast schedule setting function on the display 160. The broadcast schedule setting may comprise recording schedule and viewing schedule functions, the sliding banner display period, and the number of scheduled broadcast programs displayed in the form of the sliding banner.

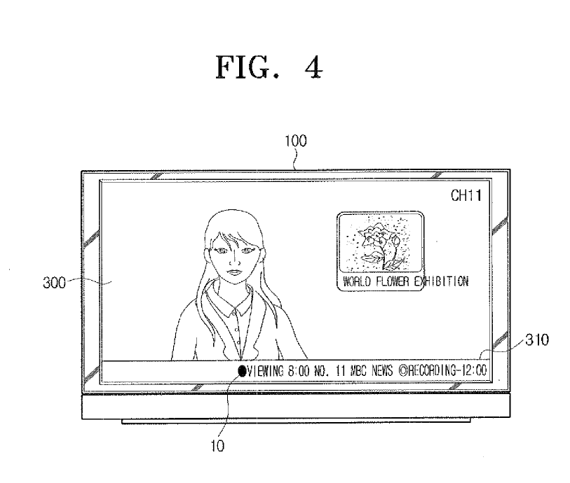

The controller 120 reads out from the storage unit 110 the broadcast program information for as many as the number of broadcast programs input through the user interface unit 130. Additionally, the controller 120 displays the read broadcast program information on the display 160 according to the sliding banner display period input through the user interface unit 130. The controller 120 arranges the broadcast program information in the order of the broadcasting time to display the information in the form of the sliding banner. The broadcast program information displayed in the form of the sliding banner will be explained with reference to FIG. 3.

FIG. 3 is an exemplary view showing a broadcast schedule list according to an exemplary embodiment of the present invention. As shown in FIG. 3, a broadcast signal is received through channel 4 on a screen 300 of the image display apparatus 100, and the broadcast schedule list of the broadcast programs scheduled for broadcasting appears at the bottom of the screen 300 in the form of a sliding banner 310. The sliding banner 310 is displayed at the bottom of the screen 300 as shown in FIG. 3, but may be displayed at the top of the screen 300 or at a position selected by a user.

Additionally, broadcast program information is displayed as either a viewing schedule or a recording schedule, and arranged in the order of the broadcasting time of each broadcast program, sliding in one direction.

The timer 140 computes the current time from the time recorded in a system time table (STT) which is contained in the broadcast signal received through the signal receiver 150.

The controller 120 compares the current time detected by the timer 140 to the broadcasting time of the broadcast program stored in the storage unit 110. If the current time corresponds to the broadcasting time, the controller 12 may perform scheduled recording or scheduled viewing.

In other words, the controller 120 changes a receiving channel to a scheduled channel, receives the scheduled broadcast program through the signal receiver 150, and displays the received broadcast program on the display 160.

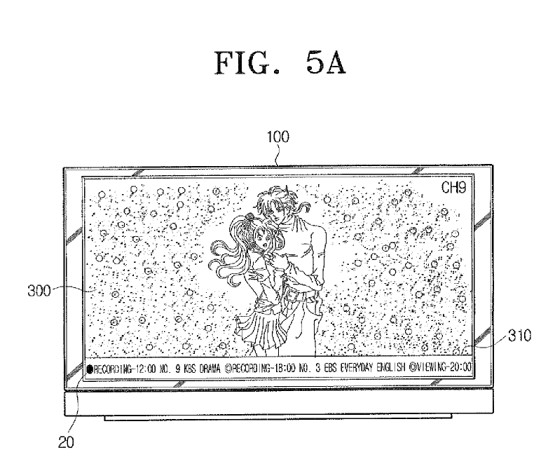

Additionally, the controller 120 causes a light to flash on the screen to indicate information on a currently received broadcast program from the information on the scheduled broadcast programs being displayed according to the sliding banner display period set at the bottom of the screen, and thus a user may check the information. This operation of the controller 120 will be explained in detail with reference to FIG. 4.

FIG. 4 is an exemplary view showing a broadcast schedule list when the broadcast programs scheduled for broadcasting are received. In FIG. 4, channel 11 scheduled for viewing is received and displayed on the screen 300 of the image display apparatus 100. The light 10 flashes on the screen to indicate the information on the currently received broadcast program from the broadcast program information displayed on the sliding banner 310.

The information on the currently received broadcast program may be displayed in a different color, a different calligraphic style, and a different font size from other broadcast programs being displayed sliding across the display screen. Additionally, the information on the currently received broadcast program may be displayed together with text informing the user that the broadcast is currently received.

Additionally, the broadcast schedule list slides according to the sliding banner display period and the number of the broadcast programs, set on the user interface in the same manner as in FIG. 3.

Accordingly, it is possible to check whether the broadcast programs scheduled for broadcasting are currently being received, and to check information on the remaining scheduled broadcast programs, on the sliding banner.

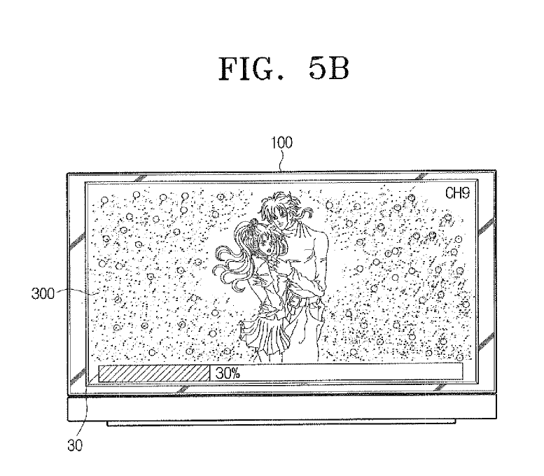

If a broadcast program scheduled for recording is received, the controller 120 may record the broadcast program and display a recording progress bar indicating the recording status of the received broadcast program on the screen. The recording progress bar and the sliding banner may be displayed simultaneously or alternately. The period in which the recording progress bar is displayed may be set to be the same period as the sliding banner display period. This operation of the controller 120 will be explained in detail with reference to FIGS. 5A and 5B.

FIG. 5A is an exemplary view showing a broadcast schedule list when the broadcast program scheduled for recording is received. In FIG. 5A, channel 9 scheduled for recording is currently received, displayed, and recorded on the screen 300 of the image display apparatus 100. The light 20 flashes on the screen to indicate information on a currently recorded broadcast program.

The channel 11 of FIG. 4 is deleted from the broadcast schedule list, and the broadcast program information for as many broadcast programs as are set by the user interface is read out from the storage unit 110 and slides across the display screen.

FIG. 5B is an exemplary view showing the recording progress bar when the broadcast program scheduled for recording is received. In FIG. 5B, a recording progress bar 30 indicating the recording status is displayed on the screen 300 of the image display apparatus 100.

Referring to FIGS. 5A and 5B, a broadcast program of channel 9 scheduled for recording is currently being received, and the recording progress bar 30 and sliding banner 310 are alternately displayed according to a regular period until the recording is completed.

Accordingly, information on the recording progress of the currently recorded broadcast program and information on the remaining scheduled broadcast programs may be checked through the recording progress bar and the sliding banner.

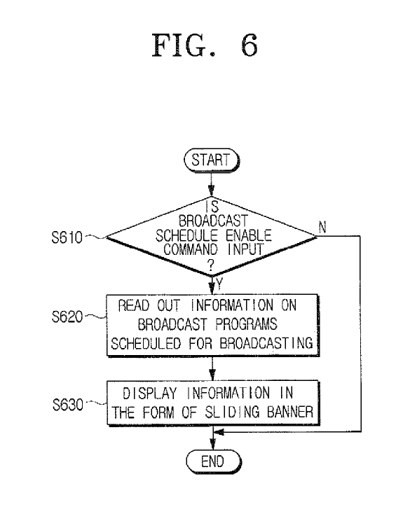

FIG. 6 is a flowchart explaining a method for displaying a broadcast schedule list of an image display apparatus according to another exemplary embodiment of the present invention. In FIG. 6, if a specific broadcast program is scheduled for broadcasting using the EPG information received from the broadcasting station, information on the scheduled broadcast program may be stored. The stored broadcast program information may comprise information relating to the name of the broadcasting station providing the broadcast program, the channel number of the received broadcast, the broadcasting time of the broadcast program, and the broadcast program title. The broadcast schedules may comprise viewing schedules or recording schedules.

Subsequently, if a broadcast schedule enable command is input in operation S610, the information on the scheduled broadcast programs may be read out in operation S620 to be displayed in the form of a sliding banner on one side of a screen in operation S630. The broadcast schedule enable command may be input by a user or input according to a preset period. The displayed program information refers to information on scheduled broadcast programs which have not been displayed in their entirety at the current time.

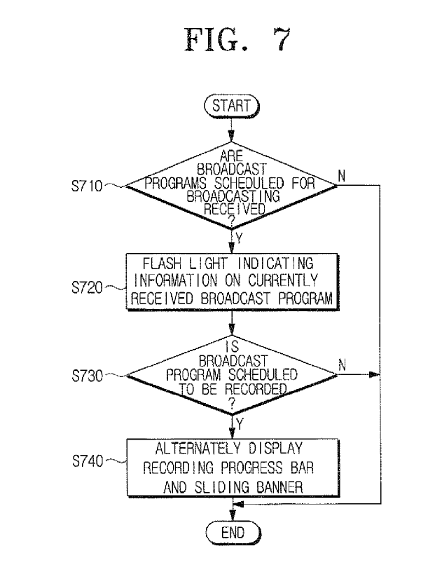

FIG. 7 is a flowchart explaining in detail the method of FIG. 6 according to another exemplary embodiment of the present invention. In FIG. 7, if the broadcast program information, as displayed in operation S630 described above is received in operation S710, the received broadcast program may be displayed on the screen. Additionally, a light indicating information on the currently received broadcast program from the broadcast program information displayed in the form of the sliding banner at operation S630 may flash on the screen in operation S720, and thus a user may check the information.

The information on the currently received broadcast program may be displayed in a different color, a different calligraphic style, and a different font size from other broadcast programs being displayed sliding across the display screen. Additionally, the information on the currently received broadcast program may be displayed together with text informing the user that the broadcast is currently received.

If the broadcast program received at operation S710 is scheduled to be recorded in operation S730, the received broadcast program may be recorded. Additionally, a recording progress bar indicating the recording status, and the sliding banner of operation S720 may be alternately displayed in operation S740. Alternatively, the recording progress bar and the sliding banner may be simultaneously displayed.

In this situation, the recording progress bar and the sliding banner may be displayed on at least one of the bottom or the top of the screen.

As described above, in the exemplary embodiments of the present invention, the list of the broadcast programs scheduled for recording is displayed in the form of a sliding banner on one side of the screen. The light flashes on the screen to indicate the information on the currently received broadcast program from the scheduled broadcast programs, which enables the user to check the information. Accordingly, the user may easily confirm the schedule list without accessing the corresponding menu individually in order to check the scheduled broadcast programs. Additionally, an obstacle to viewing broadcasts caused by having to check the schedule list may be reduced, and thus user convenience can be enhanced.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image display apparatus comprising:
a storage unit which stores information on broadcast programs scheduled for broadcasting; and
a controller which reads out the stored broadcast program information so that the information is displayed in the form of a sliding banner on one side of a screen.

2. The apparatus as claimed in claim 1, further comprising a user interface unit which receives user input regarding a sliding banner display period and the number of broadcast programs to be displayed in the form of the sliding banner,
wherein the controller reads out from the storage unit the broadcast program information for as many as the number of the broadcast programs input through the user interface unit, and arranges the read broadcast program information in the order of the broadcasting time to display the information in the form of the sliding banner according to the input sliding banner display period.

3. The apparatus as claimed in claim 1, wherein the controller causes a light to flash on the screen to indicate information on a currently received broadcast program from the broadcast program information displayed in the form of the sliding banner, if the broadcast programs scheduled for broadcasting are received.

4. The apparatus as claimed in claim 3, wherein the controller causes a light to flash on the screen to indicate information on a currently received broadcast program from the broadcast program information displayed in the form of the sliding banner, and to alternately display a recording progress bar indicating the recording status of the currently received broadcast program and the sliding banner, if a broadcast program scheduled for recording is received.

5. The apparatus as claimed in claim 1, wherein the controller displays a recording progress bar indicating the recording status, if the broadcast programs scheduled for broadcasting are received and recorded.

6. The apparatus as claimed in claim 5, wherein the controller alternately displays the recording progress bar and the sliding banner.

7. The apparatus as claimed in claim 1, wherein the controller displays the broadcast program information in the form of the sliding banner at the bottom of the screen.

8. The apparatus as claimed in claim 1, wherein the controller changes at least one of the display color, the font size and the display text of the information on the currently received broadcast program from the broadcast program information displayed in the form of the sliding banner to a type different from information on other broadcast programs, and displays the information, if one of the broadcast programs scheduled for broadcasting is received.

9. The apparatus as claimed in claim 1, wherein the broadcast schedule is one of a viewing schedule and a recording schedule.

10. A method for displaying a broadcast schedule list of an image display apparatus, the method comprising:
reading out information on broadcast programs pre-scheduled for broadcasting, if a broadcast schedule enable command is input; and
displaying the read broadcast program information in the form of a sliding banner on one side of a screen.

11. The method as claimed in claim 10, wherein the displaying comprises arranging the broadcast program information for as many as a preset number of broadcast programs in the order of the broadcasting time so that the information is displayed in the form of the sliding banner according to a regular period.

12. The method as claimed in claim 10, further comprising having a light flashing to indicate information on a currently received broadcast program from the broadcast program information displayed in the form of the sliding banner, if the broadcast programs scheduled for broadcasting are received.

13. The method as claimed in claim 12, wherein the sliding banner on which the light flashes is displayed alternately with a recording progress bar indicating the recording status, if a broadcast program scheduled for recording is received.

14. The method as claimed in claim 10, further comprising displaying a recording progress bar indicating the recording status, if the broadcast programs scheduled for broadcasting are received and recorded.

15. The method as claimed in claim 10, wherein the recording progress bar is displayed alternately with the sliding banner.

16. The method as claimed in claim 10, wherein the displaying comprises displaying the broadcast program information in the form of the sliding banner at the bottom of the screen.

17. The method as claimed in claim 10, further comprising changing at least one of the display color, the font size and the display text of the information on the currently received broadcast program from the broadcast program information displayed in the form of the sliding banner to a type different from information on other broadcast programs, and displaying the information, if one of the broadcast programs scheduled for broadcasting is received.
